(19) United States
(12) Patent Application Publication
(10) Pub. No.: US 2008/0234529 A1
(43) Pub. Date: Sep. 25, 2008

(54) Treatment of Elemental Mercury

(76) Inventors: Henry Boso Chan, Manchester (GB); Raymond Hall, Cumbria (GB)

Correspondence Address: MOORE & VAN ALLEN PLLC, P.O. BOX 13706, Research Triangle Park, NC, 27709, US

(21) Appl. No.: 10/594,202

(22) PCT Filed: Mar. 22, 2005
(86) PCT No.: PCT/GB2005/001088

§ 371 Date: Apr. 28, 2008

(30) Foreign Application Priority Data
Mar. 24, 2004 (GB) 0406532.2

(51) Int. Cl. C04B 18/04

(52) U.S. Cl. 588/257

(57) ABSTRACT

The invention concerns a method for the stabilisation and disposal of elemental mercury, the method comprising treating the elemental mercury with a cementitious particulate filler material which additionally comprises an immobilisation treatment. In a preferred embodiment, the immobilisation treatment comprises an amalgamation treatment prior to the treatment with a cementitious particulate filler material. Preferably, the amalgamation is carried out using copper powder and dilute nitric acid and the cementitious particulate filler material comprises a mixture of Ordinary Portland Cement and Blast Furnace Slag. The method of the invention is carried out conveniently and rapidly, and the end product, after allowing to cure, is non-toxic, insoluble in water, easily handled, and immediately suitable for disposal. The method is particularly applicable to the safe disposal of elemental mercury which is contaminated with radioactive materials.

### FIELD OF THE INVENTION

The present invention relates to the disposal of mercury. Most particularly, it is concerned with techniques for the treatment and safe disposal of elemental mercury, especially elemental mercury that is contaminated with radioactive materials.

### BACKGROUND TO THE INVENTION

The management of mercury wastes is an issue that has frequently had to be addressed in various industries over a long period of time, and is the subject of strict health, safety and environmental legislation in many countries in view of the highly toxic nature of these wastes. Specifically, elemental mercury presents its own additional challenges since, being a liquid at ambient temperature, it has a low but significant vapour pressure with the consequence that, in view of its high toxicity, workers handling the metal have to address the hazard of mercury vapour exposure. Thus, whilst mercury is generally less toxic and soluble in its elemental form than when comprised in various inorganic and organic compounds, additional handling problems do arise when dealing with the metal, rather than the compounds of mercury which, for the most part, comprise solid materials.

Thus, much attention has been devoted to the treatment of elemental mercury with a view to achieving its safe disposal. The techniques which have been developed have essentially focused on the immobilisation of mercury, with the most favoured methods involving either amalgamation or stabilisation.

It is well known that mercury forms semi-solid solutions, known as amalgams, with a variety of other metals. Essentially, the method relies on dissolution of mercury in the solid metal to form a solid solution, and this technique has previously found application in the extraction of precious metals, such as gold and silver, from their ores. Following amalgamation, the amalgam is subjected to a thermal treatment to volatilise the mercury and thereby recover the precious metal. Whilst the technique of amalgamation represents a convenient, speedy and relatively inexpensive process for the treatment of elemental mercury, it can be difficult to scale up, the amalgamation process may require the assistance of dilute nitric acid in order to achieve high efficiency, and the resulting amalgam is subject to attack by water, which can lead to the formation of the hydroxide of the amalgamating metal. Thus, whilst this technique is generally applicable to the disposal of elemental mercury which is contaminated with radioactive materials, the attendant disadvantages are such that amalgamation, by itself, does not constitute a suitable means for the treatment and disposal of such waste materials.

The immobilisation of mercury by stabilisation involves its conversion to an immobile species in order to reduce or eliminate the possibility of vaporisation or leaching to the environment. The immobilisation processes known from the prior art are as follows:
Sulphur stabilisation;
Sulphur polymer stabilisation/solidification; and
Chemically bonded phosphate ceramic formation.

The first of these processes involves a chemical reaction between sulphur and mercury to form mercury sulphide, which may be effected by blending and grinding a mixture of mercury and elemental sulphur under ambient conditions. The process is robust and relatively simple to carry out, and the mercury(II)sulphide which is produced is insoluble and non-volatile in water, and chemically stable and unreactive, being attacked only by concentrated acids. However, some refinement of process control is required with this method and, although not suffering from the same problems as liquid mercury, in terms of volatility and proneness to leaching, mercury(II)sulphide is still a toxic material requiring disposal and, as a fine powdery material, presents its own handling difficulties.

The sulphur polymer stabilisation/solidification process—as, for example, disclosed in U.S. Pat. No. 6,399,849—represents a modification of the basic sulphur stabilisation process, and can be used to both convert elemental mercury to mercury(II)sulphide, and simultaneously encapsulate the waste. The process relies on the use of 95 wt % elemental sulphur an 5 wt % of organic polymer modifiers, the process is robust and relatively simple to implement, and the resulting monolithic product has high mechanical strength and resistance to water and corrosive environments. However, the process has to be carried out at a relatively high temperature which may lead to some volatilisation, and consequent loss, of the liquid mercury and, in any event, requires the provision of an inert atmosphere in order to prevent the formation of water soluble mercury(II)oxide. In addition, the process is costly, and the volume of the waste material is considerably increased.

The chemically bonded phosphate ceramic approach involves an acid-base reaction between magnesium oxide and mono-potassium dihydrogen phosphate in solution, which produces a hard, dense ceramic. Thus, water, the mercury waste, the oxide, the phosphate and other required ingredients for mercury fixation are blended together for about 30 minutes to produce an exothermic reaction which leads to both chemical stabilisation and physical encapsulation of the mercury waste. After cessation of mixing, the waste form sets in about two hours and is then left to cure for around two weeks. This technique does, however, rely on the additional ingredients in the mixture in order to stabilise the mercury, since the ceramic alone is unable to achieve this objective; thus, careful process control is necessary. In addition, the long term stability and durability of the final waste forms have yet to be established.

Thus, it can be seen that various techniques are provided by the prior art for the disposal of elemental mercury, and that each has its particular advantages. However, some difficulties are associated with all of the processes and, as a consequence, their general applicability tends to be limited. The requirement for optimisation of process control with some of the methods, unfavourable cost factors in other cases, and questions relating to the nature or stability of the final waste products from each of the processes have resulted in attempts to provide a method for the disposal of elemental mercury which is free from such difficulties and uncertainties, and which offers a disposal route which is relatively simple to implement, consistently repeatable, robust and cost effective, in addition to providing a final waste form having excellent durability and long term stability, which is relatively free from handling problems.

The present inventors have investigated the possibility of providing a process for the stabilisation and disposal of elemental mercury which is rapid, convenient and relatively cheap to carry out, and which provides a final waste form which is non-toxic or less toxic than elemental mercury, is easy to handle and presents minimum health risks to workers, has good long term stability and durability, and contains minimum amounts of leachable substances, and is thereby suitable for disposal. Surprisingly, it has been found that such a process is available by means of a straightforward process which provides for the cement encapsulation of the mercury. The process has been shown to be adaptable to the handling to elemental mercury and associated wastes, such as aqueous solvents, and to be suitable for application to industrial scale processes.

### STATEMENTS OF INVENTION

Thus, according to the present invention, there is provided a method for the stabilisation and disposal of elemental mercury, said method comprising treating the elemental mercury with a cementitious particulate filler material, wherein said method additionally comprises an immobilisation treatment.

Any suitable cementitious material may be used for the performance of the method of the invention, but the most satisfactory results are achieved when using Ordinary Portland Cement (OPC).

Preferably, at least one additional filler is added to the cementitious material; the preferred fillers comprise inorganic materials, but certain organic materials also find application in the method of the invention. Suitable fillers include pulverised fuel ash, hydrated lime, finely divided silica, limestone flour and organic and inorganic fluidising agents, but the most preferred additional filler is Blast Furnace Slag (BFS).

Following treatment of the elemental mercury with the cementitious particulate filler material, the resulting mixture is allowed to cure at ambient temperature. It is generally found that the mixture is fully cured after a period of around 24-48 hours, when a homogeneous concrete monolith is formed.

According to the method of the present invention, the elemental mercury is subjected to an immobilisation treatment prior to the treatment with a cementitious particulate filler material. Any of the known immobilisation treatments of the prior art may be employed for this purpose. Specifically, the elemental mercury may be subjected to an amalgamation process, or a stabilisation treatment by means of sulphur stabilisation, sulphur polymer stabilisation/solidification or the formation of a chemically bonded phosphate ceramic. Most preferably, however, the elemental mercury is treated with an amalgamating metal.

Thus, according to a preferred embodiment of the present invention, there is provided a method for the stabilisation and disposal of elemental mercury, said method comprising:
(a) treating elemental mercury with an amalgamating metal; and
(b) treating the resulting amalgam with a cementitious particulate filler material.

The resulting mixture is allowed to cure at ambient temperature for around 24-48 hours to form a homogeneous amalgam/cement matrix.

It is found that especially satisfactory results are obtained when the amalgamation process is carried out in the presence of a dilute mineral acid, and when suitable mixing techniques are employed at each stage of the process. Thus, according to a particularly preferred embodiment of the invention, there is provided a method for the stabilisation and disposal of elemental mercury, the method comprising:
(a) treating elemental mercury with an amalgamating metal and a dilute aqueous acid;
(b) subjecting the resulting mixture to vigorous agitation to form an amalgam sludge;
(c) adding a cementitious particulate filler material to the amalgam sludge with stirring; and
(d) allowing the resulting mixture to cure.

### DESCRIPTION OF THE INVENTION

The mercury may be treated with any suitable amalgamating metal including, for example, silver, gold, zinc or tin. However, the most preferred amalgamating metal is copper. The amalgamating metal is preferably provided in the form of a fine powder, thereby giving the maximum surface area and promoting increased efficiency of reaction. Optimum results are achieved when using a mercury to amalgamating metal ratio of between 1:4 and 1:1 w/w, with the greatest success being observed when the ratio is in the region of 2:3 w/w. Any dilute aqueous acid may be employed, but optimum results are achieved with dilute aqueous mineral acids, most preferably dilute nitric acid. The acid concentration is generally in the region of 1M to 0.01M, but preferably around 0.1M. The acid is usually employed at a ratio of 1:2 to 2:1 w/v, preferably 1:1 w/v, in relation to the amalgamating metal.

The amalgamation mixture is subjected to vigorous agitation until the amalgamation reaction is complete, and this can be detected by the absence of free elemental mercury in the reaction vessel. The reaction proceeds to completion rapidly and, when the reaction is performed on a laboratory scale, the agitation can usually be discontinued after a period of less than 15 minutes, with satisfactory results generally being achieved in around 5-10 minutes.

When an amalgamation treatment is employed, the resulting mixture is usually in the form of an amalgam sludge, which is suitable for treatment with an appropriate cementitious particulate filler material such as Ordinary Portland Cement (OPC).

The treatment of an amalgam sludge with a cementitious particulate filler material is preferably carried out by the gradual addition of the cementitious material to the sludge with gentle stirring to promote efficient mixing. If necessary, additional water is added to the mixture during this stage of the process in order to preserve an even creamy consistency throughout the addition process.

In this embodiment of the invention, the cementitious particulate filler material, which preferably incorporates one or more additional inorganic fillers, is added to the amalgam sludge in a ratio of from 4:1 w/w (cementitious material to amalgam) to 1:2 w/w, preferably 3:1 w/w to 1:1 w/w, most preferably around 1:1 w/w.

In the preferred embodiments of the invention wherein one or more additional inorganic fillers is added to the cementitious material, the cementitious powder mixture preferably comprises additional inorganic filler and cementitious particulate material in a ratio of from 5:1 to 1:1 w/w, with the preferred ratio being in the region of 3:1 w/w.

The process of the present invention is carried out conveniently and rapidly. The preferred embodiments of the invention, wherein amalgamation is carried out before encapsulation, effectively comprise one-pot processes, wherein amalgamation and encapsulation may be carried out in the same reaction vessel, using the same mixing apparatus. The entire procedure is conducted at room temperature, with the amalgamation stage, in laboratory scale experiments, generally being complete in around 5-10 minutes.

The waste end product obtained from the method of the invention is non-toxic, insoluble in water and easily handled, and has the advantage of being immediately suitable for disposal without the requirement for any further treatment. However, in the event that it is subsequently necessary to recover elemental mercury from the concrete matrix, this may be achieved by crushing the material and distilling to remove the mercury.

The method of the present invention is particularly applicable to the safe disposal of elemental mercury which is contaminated with radioactive materials.

The method of the present invention will now be illustrated, without limitation, by reference to the following examples.

### EXAMPLES

### Example 1

A mixture of elemental mercury (20 g), copper powder (30 g) and dilute nitric acid (0.1M; 30 ml) was placed in a plastic bottle incorporating a screw cap. The bottle was sealed with the screw cap and vigorously agitated by hand for 5 minutes to form a burgundy coloured amalgam sludge.

The amalgam sludge was poured from the plastic bottle into a plastic basin equipped with a stirrer. A mixture of OPC (40 g) and BFS (120 g) was gradually added to the amalgam sludge, using very gentle stirring, initially by hand, in order to form a mixture having a smooth, creamy consistency. Additional water was added, as necessary, to the mixture in order to maintain this consistency.

Following completion of the addition, the mixture was covered and allowed to stand for 48 hours at ambient temperature, after which a homogeneous mercury-copper amalgam/cement matrix was formed, which was suitable for immediate disposal.

### Example 2

This example demonstrates the applicability of the method on a larger scale than described in Example 1 and demonstrates the applicability of the method to larger scale operations.

Elemental mercury (100 g), copper (150 g) and 0.1M HNO₃ (150 ml) were mixed together in a polythene bottle using an overhead stirrer. The mixture was stirred at 1000 rpm for 30 minutes, after which time a mixture of BFS and OPC (ratio 3:1 w/w; 400 g) was gradually added to the slurry with continuous stirring at a reduced speed of 900 rpm. The quantities employed ensured amalgam loading of around 36%, and 14% Hg loading. Additional water was added as necessary to maintain a thick, creamy consistency. By the end of the procedure, an additional 15.4 g of water had been added. The mixture was then poured into a large, square weighing boat, covered, and left to cure. After standing for 24 hours the mixture had cured into a hard monolith, homogenous apart from the presence of a thin film of copper(II)nitrate on the surface, although this flaked off when disturbed.

1. A method for the stabilisation and disposal of elemental mercury, said method comprising treating the elemental mercury with a cementitious particulate filler material, wherein said method additionally comprises an immobilisation treatment.

2. The method as claimed in claim 1 wherein said immobilisation treatment comprises a stabilisation treatment comprising sulphur stabilisation, sulphur polymer stabilisation/solidification or the formation of a chemically bonded phosphate ceramic.

3. The method as claimed in claim 1 wherein said immobilisation treatment comprises an amalgamation process.

4. The method as claimed in claim 1 which comprises:
(a) treating elemental mercury with an amalgamating metal; and (b) treating the resulting amalgam with a cementitious particulate filler material.

5. The method as claimed in claim 4 wherein said amalgamation process comprises treating elemental mercury with an amalgamating metal and a dilute aqueous acid.

6. The method as claimed in claim 5 which comprises:
(a) treating elemental mercury with an amalgamating metal and a dilute aqueous acid;
(b) subjecting the resulting mixture to vigorous agitation to form an amalgam sludge;
(c) adding a cementitious particulate filler material to the amalgam sludge with stirring; and
(d) allowing the resulting mixture to cure.

7. The method as claimed in claim 4 wherein said amalgamating metal comprises copper, silver, gold, zinc or tin.

8. The method as claimed in claim 7 wherein said amalgamating metal is copper.

9. A The method as claimed in claim 4 wherein said amalgamating metal is provided in the form of a fine powder.

10. The method as claimed in claim 4 wherein the ratio of mercury to amalgamating metal is between 1:4 and 1:1 w/w.

11. The method as claimed in claim 10 wherein said ratio is in the region of 2:3 w/w.

12. The method as claimed in claim 5 wherein said dilute aqueous acid comprises a dilute aqueous mineral acid.

13. The method as claimed in claim 12 wherein said dilute aqueous mineral acid comprises dilute nitric acid.

14. The method as claimed in claim 5 wherein the acid concentration is in the region of IM to 0.01M.

15. The method as claimed in claim 14 wherein said acid concentration is around 0.1M.

16. The method as claimed in claim 5 wherein the acid is present at a ratio of 1:2 to 2:1 w/v in relation to the amalgamating metal.

17. The method as claimed in claim 16 wherein said ratio of acid to amalgamating metal is 1:1 w/v.

18. The method as claimed in claim 6 wherein agitation of the amalgamation reaction is discontinued after a period of less than 15 minutes.

19. The method as claimed in claim 18 wherein the agitation is discontinued after 5-10 minutes.

20. The A method as claimed in claim 3 wherein additional water is added to the mixture during the addition of the cementitious particulate filler material to the amalgam sludge in order to preserve the consistency of the mixture throughout the addition process.

21. The method as claimed in claim 3 wherein the cementitious particulate filler material is added to the amalgam sludge in a ratio of from 4:1 w/w (cementitious material to amalgam) to 1:2 w/w.

22. The method as claimed in claim 21 wherein said ratio is from 3:1 w/w to 1:1 w/w.

23. The method as claimed in claim 22 wherein said ratio is around 1:1 w/w.

24. The method as claimed in claim 1 wherein said cementitious particulate filler material comprises Ordinary Portland Cement (OPC).

25. The method as claimed in claim 1 wherein said cementitious material comprises at least one additional filler.

26. The method as claimed in claim 25 wherein said at least one additional filler comprises at least one additional inorganic filler.

27. The method as claimed in claim 25 wherein said at least one additional filler comprises pulverised fuel ash, hydrated lime, finely divided silica, limestone flour or organic and inorganic fluidising agents.

28. The method as claimed in claim 25 wherein said at least one additional filler comprises Blast Furnace Slag (BFS).

29. A The method as claimed in claim 25 wherein said cementitious material comprises additional filler and cementitious particulate material in a ratio of from 5:1 to 1:1 w/w.

30. The method as claimed in claim 29 wherein said ratio is in the region of 3:1 w/w.

31. The method as claimed in claim 1 wherein the resulting mixture is allowed to cure at ambient temperature.

32. The method as claimed in claim 31 wherein the resulting mixture is allowed to cure for a period of around 24-48 hours.

33. The method as claimed in claim 25 whenever applied to the safe disposal of elemental mercury which is contaminated with radioactive materials.
